(19) United States
(12) Patent Application Publication
(10) Pub. No.: US 2005/0151984 A1
(43) Pub. Date: Jul. 14, 2005

(54) Apparatus and method of controlling density of dot line

(76) Inventor: Seung-myun Lee, Anyang-si (KR)

Correspondence Address: STANZIONE & KIM, LLP, 1740 N STREET, N.W., FIRST FLOOR, WASHINGTON, DC, 20036, US

(21) Appl. No.: 11/023,672

(22) Filed: Dec. 29, 2004

(30) Foreign Application Priority Data
Jan. 9, 2004 (KR) 2004-1426

(51) Int. Cl. H04N 1/407; H04N 1/409; H04N 1/387; G06F 9/44; G06F 3/12

(52) U.S. Cl. 358/1.9; 382/258; 358/3.27; 719/328; 358/452

(57) ABSTRACT

An apparatus and method of controlling a density of a dot line by enabling a user to control the density of the dot line, thereby satisfying user needs and desires regarding a printed density of the dot line that is unsatisfactory due to hardware limitations of an image forming apparatus. The apparatus to control the density of the dot line expressed by dots connecting a starting point and an end point of the dot line includes a dot line density setting unit to enable a user to set the density of the dot line created by a predetermined application program, and a dot line density controller to control a rendering module of an image forming apparatus such that the rendering module can render the dot line at a density set by the dot line density setting unit.

### CROSS-REFERENCE TO RELATED APPLICATIONS

This application claims the priority of Korean Patent Application No. 10-2004-1426, filed on Jan. 9, 2004, in the Korean Intellectual Property Office, the disclosure of which is incorporated herein in its entirety by reference.

### BACKGROUND OF THE INVENTION

1. Field of the Invention

The present general inventive concept relates to an apparatus and method of controlling the density of a dot line expressed by dots connecting a starting point and an end point of the dot line, and more particularly, to an apparatus and method of controlling the density of a dot line by enabling a user to control the density of the dot line, thereby satisfying user needs for the printed density of the dot line in an image forming apparatus.

2. Description of the Related Art

In order to drive a printer, which is one of image forming apparatuses, a printer driver is installed in a computer connected to the printer. When a user issues a print command to print a document created by an application program installed in the computer, the application program transmits contents of the document to the printer driver. The printer driver converts the contents into data that the printer can process, and then transmits the data to the printer. Then, the printer receives and then prints the data. This process will be described in more detail with reference to FIG. 1.

FIG. 1 is a schematic block diagram of a conventional printing system. Referring to FIG. 1, an image forming apparatus 50 is connected to a computer 10. The computer 10 includes an application program 12, such as a document editor or a graphics editor, and a printer driver 14 required for printing by the image forming apparatus 50. The computer 10 also includes a communications interface 16 for transmitting first data to the image forming apparatus 50.

The image forming apparatus 50 includes an image forming engine 52, a communications interface 54, a rendering module 56, and a video frame module 58. The rendering module 56 renders the first data received from the computer 10 via the communications interface 54 into second data appropriate for the image forming apparatus 50. The video frame module 58 converts the second data rendered by the rendering module 56 into a video frame and transmits the video frame to the image forming engine 52.

The printing system performs printing as follows. For example, when a user of the computer 10 intends to print a document using the image forming apparatus 50, the printer driver 14 receives third data from the application program 12 using an operating system of the computer 10. After receiving the third data, the printer driver 14 converts the third data into the first data that the image forming apparatus 50 can process, and then transmits the first data to the image forming apparatus 50 via the communications interface 16. After the image forming apparatus 50 receives the first data from the computer 10 via the communications interface 54, the rendering module 56 renders the first data into the second data that can be processed by the image forming apparatus 50. Then, the video frame module 58 converts the second data into the video frame. Once the video frame is created, it is printed by the image forming engine 52.

Assuming that the image forming engine 52 is an electrophotographic image forming engine, it prints the video frame (image) onto a recording medium through charging, laser exposing, developing and transferring processes.

When the user intends to print a dot line created by the application program 12, the printer driver 14 transmits a starting point (start X and start Y of the dot line), an end point (end X and end Y of the dot line), and a print command language to the image forming apparatus 50. The rendering module 56 renders the dot line using the starting point, the ending point, and a rendering algorithm. Then, the image forming engine 52 prints the dot line.

U.S. Pat. No. 5,258,850 discloses a printing system which controls the density of a printed output by changing the number of dots printed in a dot line. However, a conventional developer included in an image forming engine fails to fully express the dot line and satisfy user needs for the printed quality of the dot line.

### SUMMARY OF THE INVENTION

The present general inventive concept provides an apparatus and method of controlling a density of a dot line by enabling a user to control the density of the dot line, thereby satisfying user needs for a printed density of the dot line that is unsatisfactory due to hardware limitations of an image forming apparatus.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept may be achieved by providing an apparatus to control a density of a dot line expressed by dots connecting a starting point and an end point of the dot line. The apparatus includes a dot line density setting unit to enable a user to set the density of the dot line created by a predetermined application program, and a dot line density controller to control a rendering module of an image forming apparatus such that the rendering module can render the dot line to a density set by the dot line density setting unit.

The dot line density setting unit may be included in a printer driver that is installed in a computer connected to the image forming apparatus or may be included in operating panel equipment of the image forming apparatus. The dot line density controller may be included in the printer driver that is installed in the computer connected to the image forming apparatus. The dot line density setting unit may set a density-increase value to be added to an original density value of the dot line and a density-decrease value to be subtracted from the original density of the dot line.

The foregoing and/or other aspects and advantages of the present general inventive concept may also be achieved by providing a method of controlling a density of a dot line represented by dots connecting a starting point and an end point of the dot line. The method includes setting the density of the dot line by enabling a user to control the density of the dot line created by a predetermined application program and adjusting the density of the dot line by controlling a rendering module of an image forming apparatus such that the rendering module can render the dot line to a density set after the setting of the density of the dot line.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic block diagram of a conventional printing system;

FIG. 2 is a block diagram illustrating an apparatus to control a density of a dot line according to an embodiment of the present general inventive concept;

FIG. 3 is a block diagram illustrating an apparatus to control a density of a dot line according to another embodiment of the present general inventive concept;

FIG. 4 is a flowchart illustrating a method of controlling a density of a dot line according to another embodiment of the present general inventive concept;

FIG. 5A illustrates an original dot line;

FIG. 5B illustrates a dot line after an original density of the original dot line is decreased by 50 percent;

FIG. 5C illustrates a dot line after the original density of the original dot line is increased by 50 percent; and

FIG. 5D illustrates a dot line after the original density of the original dot line is increased by 100 percent.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

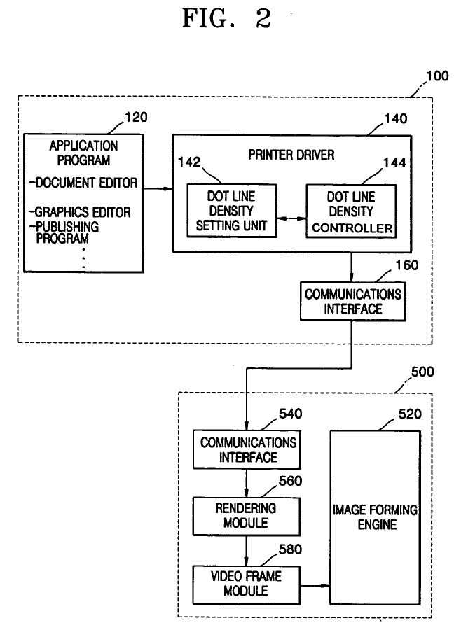

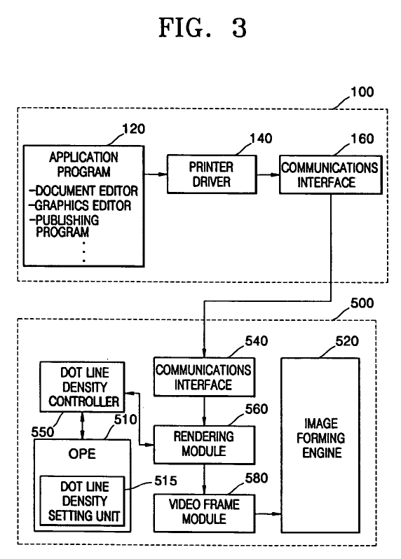

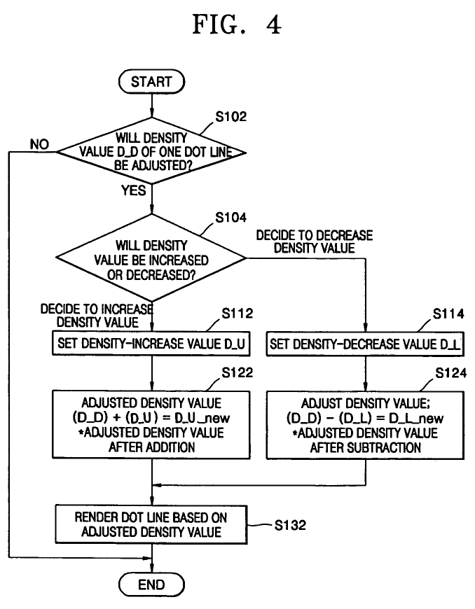

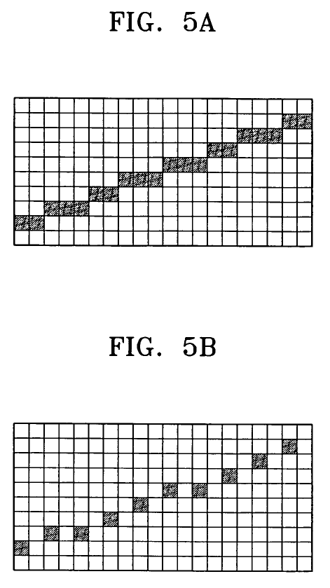

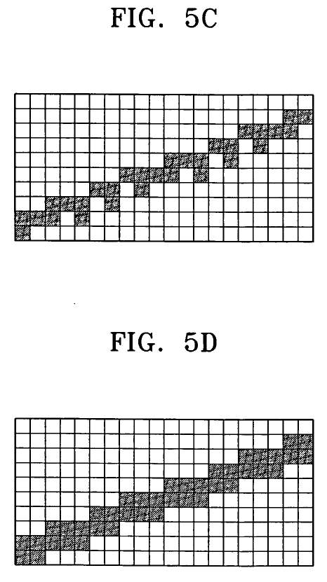

FIG. 2 is a block diagram of an apparatus to control a density of a dot line according to an embodiment of the present general inventive concept. FIG. 3 is a block diagram of another apparatus to control a density of a dot line according to another embodiment of the present general inventive concept. FIG. 4 is a flowchart illustrating a method of controlling a density of a dot line according to another embodiment of the present general inventive concept. FIGS. 5A through 5D illustrate an original dot line, a dot line after an original density of the original dot line is decreased by 50 percent, a dot line after the original density of the original dot line is increased by 50 percent, and a dot line after the original density of the original dot line is increased by 100 percent, respectively.

Referring to FIG. 2, the apparatus may include a computer 100 and an image forming apparatus 500. In the computer 100, a printer driver 140 included in the apparatus controlling the density of a dot line according to an embodiment of the present invention includes a dot line density setting unit 142 and a dot line density controller 144. The dot line density setting unit 142 enables a user to set the density of the dot line (See FIG. 5A) created by an application program 120 such as a document editor and a graphics editor. The dot line density controller 144 controls a rendering module 560 of an image forming apparatus 500 such that the rendering module 560 renders the density of the dot line to a value set by the dot line density setting unit 142. The dot line density setting unit 142 and the dot line density controller 144 may be program modules.

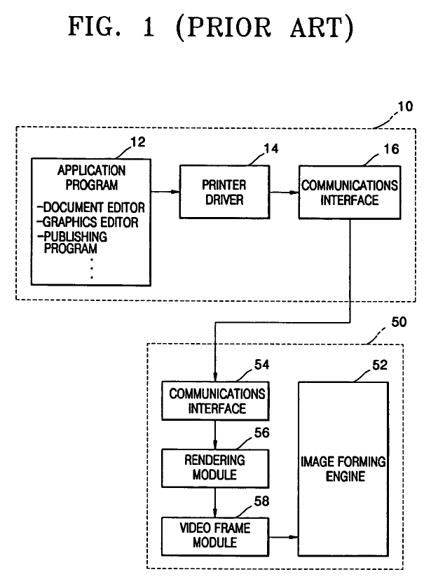

A communications interface 540, a video frame module 580, and an image forming engine 520 included in the apparatus to control the density of the dot line of FIG. 2 perform the same functions as their corresponding elements illustrated in FIG. 1.

The dot line density setting unit 142 receives an input signal corresponding to the set density of the dot line from the user through a window provided on a display (not shown) connected to the computer 100 or a keyboard (not shown) provided in the computer 100. The dot line density controller 144 may transmit a signal relating to the set density of the dot line to the image forming apparatus 500 together with print data relating to the dot line. Upon receiving the signal of the set density of the dot line from the computer 100 through the dot line density controller 144, the rendering module 560 can render the density of the dot line to be printed according to the print data and the signal corresponding to the set density of the dot line by the dot line density setting unit 142, so that the density of the printed dot line is adjusted.

Referring to FIG. 3, the image forming apparatus 500 of the apparatus to control the density of the dot line includes a dot line density setting unit 515 and a dot line density controller 550. The dot line density setting unit 515 enables a user to set the density of the dot line created by an application program 120, such as a document editor and a graphics editor. The dot line density controller 550 controls a rendering module 560 of the image forming apparatus 500 such that the rendering module 560 renders the dot line to a density set by the dot line density setting unit 515. As shown in FIG. 3, the image forming apparatus 500 has installed therein the dot line density adjuster 550 and has operating panel equipment (OPE) 510 including the dot line density setting unit 515. The dot line density setting unit 515 and the dot line density controller 550 may be program modules.

The dot line density setting unit 515 receives an input signal corresponding to the set density of the dot line through a window provided in a display (not shown) of the image forming apparatus 500 or a keyboard (not shown) provided in the image forming apparatus 500. The dot line density controller 550 may transmit a signal relating to the set density of the dot line to the rendering module of the image forming apparatus 500 which receives the print data relating to the dot printer and/or other images. Upon receiving the signal of the set density of the dot line from the dot line density controller 550, the rendering module 560 can render the density of the dot line to be printed on a sheet of paper according to the print data and the signal corresponding to the set density by the dot line density setting unit 515, so that the density of the printed dot line is adjusted.

Referring to FIG. 4, the method of controlling the density of the dot line includes operations of deciding whether a user desires to adjust a density value D_D of a dot line (S102), deciding whether the user desires to increase or decrease the density value D_D of the dot line when the user desires to adjust the density value D_D (S104), setting a density-increase value D_U or a density-decrease value D_L depending on whether the user decided to increase or decrease the density value D_D (S112 or S114), calculating a new density value D_U_new or D_L_new by adding/subtracting the set density-increase D_U or density-decrease value D_L to/from the density value D_D (S122 or S124), and rendering the dot line into the new density value (S132).

The apparatus and method of controlling the density of a dot line according to the present invention will be described in more detail with reference to FIGS. 2 through 5. FIG. 5A illustrates the original dot line rendered without using the apparatus and method of the present general inventive concept.

For example, when a user is unsatisfied with a printed output of a dot line, the user indicates the desire to control a density value of the dot line, using the printer driver 140 or the OPE 510 (S102). Then, the user decides whether to increase the density value D_D or decrease the density value D_D (S104). If the user decides to increase the density value D_D, the user sets a desired percentage density-increase value D_U using the dot line density setting unit 142 of the printer driver 140 or the dot line density setting unit 515 of the OPE 510 (S114). If the user decides to decrease the density value D_D, the user sets a desired percentage density-decrease value D_L (S114).

When the density-increase value D_U is set, the dot line density controller 144 or 500 calculates a new density value D_U_new by adding the density-increase value D_U to the density value D_D of the dot line such that the new density value D_U_new can be used in the rendering module 560 (S122). In contrast, when the density-decrease value D_L is set, the dot line density controller 144 or 500 calculates a new density value D_L_new by subtracting the set density-decrease value D_L from the density value D_D of the dot line such that the new density value D_L_new can be used by the rendering module 560 (S124).

When the new density value D_U_new or D_L_new calculated by the dot line density controller 144 or 550 is transmitted to the rendering module 560, the rendering module 560 renders the dot line based on the new density value D_U_new or D_L_new (S132). The dot line rendered based on the new density value D_U_new or D_L_new is illustrated in FIGS. 5B through 5D.

FIG. 5B illustrates the dot line after subtracting a value representing 50% of the density (of an original density value) from the original density value (100%) of the original dot line of FIG. 5A. FIG. 5C illustrates the dot line after adding a value representing 50% of the density (of the original density value) to the original density value (100%) of the original dot line. FIG. 5D illustrates the dot line after adding a 100% density value (of the original density value) to the original density value (100%) of the original dot line. As shown in FIGS. 5A through 5D, the dot line may have a length, a thickenss, and the original density, which are set during creating the dot line using the application program. In this embodiment, the dot line may be printed according to the lenth, the thickness, and the set or adjusted density in the image forming apparatus.

It is possible that a white line will be formed after subtracting a 100 percent density value from the original density value of the original dot line. It is also possible that, in a case of a colored dot line, the new density value D_U_new or D_L_new will be applied to each of red, green, and blue (RGB) colors.

Therefore, the present invention may acquire a printed output of a dot line with a desired density by enabling a user to control the density of the dot line when the density of the dot line printed is not even roughly equal to the value the user desired due to hardware characteristics of a developer of an image forming apparatus or other reasons.

As described above, an apparatus and method of controlling the density of a dot line according to the present general inventive concept enables a user to control the density of the dot line, thereby satisfying user needs and desires regarding the printed density of the dot line that is unsatisfactory due to the hardware limitations of the image forming apparatus.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An apparatus to control an image forming apparatus to print a dot line expressed by dots connecting a starting point and an end point of the dot line, comprising:
a dot line density setting unit to set a density of a dot line created by a predetermined application program; and
a dot line density controller to control the dot line to be rendered according to the set density.

2. The apparatus of claim 1, further comprising:
a computer connected to the image forming apparatus and having a printer driver,
wherein the dot line density setting unit is installed in the printer driver.

3. The apparatus of claim 1, wherein the image forming apparatus comprises an operating panel, and the dot line density setting unit is installed in the operating panel.

4. The apparatus of claim 1, further comprising:
a computer connected to the image forming apparatus and having a printer driver,
wherein the dot line density controller is installed in the printer driver.

5. The apparatus of claim 1, further comprising:
an image forming apparatus to print the dot image,
wherein the dot line density controller is installed in the image forming apparatus.

6. The apparatus of claim 1, wherein the dot line has an original density value, and the dot line density setting unit generates a density-increase value to be added to the original density value of the dot line and a density-decrease value to be subtracted from the original density value of the dot line to adjust the density of the dot line.

7. The apparatus of claim 1, wherein the dot line density setting unit receives an input signal to set the density of the dot line.

8. The apparatus of claim 1, wherein the image forming apparatus comprises a rendering module to render the dot line to be printed, and the dot line density controller controls the rendering module to render the dot line according to the set density of the dot line.

9. The apparatus of claim 1, wherein the dot line density setting unit allows a user to input a signal corresponding to the set density of the dot line after the dot line is created using the application program.

10. The apparatus of claim 1, wherein the dot line density setting unit receives a user input signal corresponding to the set density of the dot line after the dot line is created using the application program.

11. The apparatus of claim 1, wherein the image forming apparatus stores print data relating to the dot line created by the application program, and the dot line density controller controls the image forming apparatus to render the dot line according to the print data and the set density.

12. An apparatus to control an image forming apparatus to print a dot line expressed by dots connecting a starting point and an end point of the dot line, comprising:
a dot line density setting unit to adjust a density of a dot line created by a predetermined application program, so that the density of the dot line is adjusted according to the set density when the dot line is printed.

13. The apparatus of claim 12, wherein the dot line has an original density value, and the dot line density setting unit generates a density-increase value to be added to the original density value of the dot line and a density-decrease value to be subtracted from the original density value of the dot line to adjust the density of the dot line.

14. A method of controlling a density of a dot line represented by dots connecting a starting point and an end point of the dot line, comprising:
setting the density of the dot line created by a predetermined application program; and
adjusting the density of the dot line by controlling a rendering module of an image forming apparatus such that the rendering module can render the dot line to a density set after the setting of the density of the dot line.

15. The method of claim 14, wherein the setting of the density of the dot line comprises setting the density in a printer driver installed in a computer connected to the image forming apparatus.

16. The method of claim 14, wherein the setting of the density of the dot line comprises setting the density in operating panel equipment of the image forming apparatus.

17. The method of claim 14, wherein the adjusting of the density of the dot line comprises adjusting the density in a printer driver installed in the computer connected to the image forming apparatus.

18. The method of claim 14, wherein the adjusting of the density of the dot line comprises adjusting the density in the image forming apparatus.

19. The method of claim 14, wherein the dot line has an original density value when being created by the application program, and the setting of the density of the dot line comprises:
setting a predetermined density value; and
determining whether to add the predetermined density value to the original density value of the dot line or whether to subtract the predetermined density value from the original density value of the dot line, so that the density of the dot line is adjusted.

20. The method of claim 14, wherein the setting of the density of the dot line comprises:
allowing a user to control the density of the dot line through a window or a keyboard.
